(19) United States
(12) Patent Application Publication
(10) Pub. No.: US 2025/0121606 A1
(43) Pub. Date: Apr. 17, 2025

(54) INKJET PRINTING METHOD AND INKJET PRINTING APPARATUS

(71) Applicant: Samsung Display Co., LTD., Yongin-si (KR)

(72) Inventors: SATOSHI TOMOEDA, Yongin-si (KR); Setsu Takeuchi, Yongin-si (KR); CHANSUNG JUNG, Yongin-si (KR); MYUNGSOO HUH, Yongin-si (KR)

(73) Assignee: Samsung Display Co., LTD., Yongin-si (KR)

(21) Appl. No.: 18/823,047

(22) Filed: Sep. 3, 2024

(30) Foreign Application Priority Data
Oct. 12, 2023 (KR) 10-2023-0136300

(51) Int. Cl. B41J 2/205; B41J 2/045

(52) U.S. Cl. CPC B41J 2/2054; B41J 2/04586; B41J 2/04588; B41J 2/04593

(57) ABSTRACT

An inkjet printing method includes generating an initial sequence in which initial numbers are arranged in a matrix form, generating a correction sequence by correcting the initial numbers with correction numbers based on a variable range for a volume of droplets ejected into pixel areas and measurement error range for discharge volume of nozzles which discharge droplets to the pixel areas, and discharging droplets to the pixel areas while adjusting a discharge volume for each nozzle based on the correction sequence.

### CROSS-REFERENCE TO RELATED APPLICATION

This application claims priority to and benefits of Korean Patent Application No. 10-2023-0136300 under 35 U.S.C. § 119, filed on Oct. 12, 2023, the entire content of which are incorporated herein by reference.

### BACKGROUND

### 1. Technical Field

The disclosure relates to an inkjet printing method. More specifically, the disclosure relates to an inkjet printing method and an inkjet printing apparatus for performing the inkjet printing method.

### 2. Description of the Related Art

A display device is a device that displays images to provide visual information to users. The display device may be manufactured using an inkjet printing method. The inkjet printing method may be performed using an inkjet printing apparatus that forms an opening (e.g., a pixel area) on a substrate and ejects ink into the opening.

### SUMMARY

Embodiments provide an inkjet printing method with improved reliability.

Embodiments provide an inkjet printing apparatus that performs the inkjet printing method.

The technical objectives to be achieved by the disclosure are not limited to those described herein, and other technical objectives that are not mentioned herein would be clearly understood by a person skilled in the art from the description of the disclosure.

An inkjet printing method according to an embodiment includes generating an initial sequence in which initial numbers are arranged in a matrix form, generating a correction sequence by correcting the initial numbers with correction numbers based on a variable range for a volume of droplets ejected into pixel areas and a measurement error range for discharge volume of nozzles which discharge droplets to the pixel areas, and discharging droplets to the pixel areas while adjusting a discharge volume for each nozzle based on the correction sequence.

In an embodiment, the variable range may be about −A % to about +A %, the measurement error range may be about −B % to about +B %, each of A and B is a positive number, and B is smaller than A, and in the generating of the correction sequence, a maximum value among the initial numbers may be corrected to a number calculated by Equation 1 below.

$$A - B \qquad [ Equation 1 ]$$

In an embodiment, in the generating of the correction sequence, the minimum value among the initial numbers may corrected to a number calculated by Equation 2 below.

$$- ( A - B ) \qquad [ Equation 2 ]$$

In an embodiment, for remaining numbers other than the maximum value and the minimum value among the initial numbers, in case that C is a ratio of any one remaining number to a difference between the maximum value and the minimum value, in the generating of the correction sequence, the remaining number may be corrected to a number calculated by Equation 3 below.

$$( A - B ) \times ( 2 C - 1 ) \qquad [ Equation 3 ]$$

In an embodiment, the variable range may be about −A % to about +A %, the measurement error range may be about −B % to about +B %, each of A and B may be a positive number, and B may be smaller than A, in the generating of the correction sequence, a maximum value among the initial numbers may be corrected to A, and a minimum value among the initial numbers may be corrected to −A, and for remaining numbers other than the maximum value and the minimum value among the initial numbers, in case that C is a ratio of any one remaining number to a difference between the maximum value and the minimum value, in the generating of the correction sequence, the remaining number may be corrected to a number calculated by Equation 4 below

$$A \times ( 2 C - 1 ) . \qquad [ Equation 4 ]$$

In an embodiment, in the discharging of droplets to the pixel areas, the correction numbers may correspond to the pixel areas.

In an embodiment, in the discharging of droplets to the pixel areas, a discharge volume of a nozzle corresponding to a pixel area among the pixel areas may be adjusted based on a correction number corresponding to the pixel area.

In an embodiment, the discharge volume of the nozzle corresponding to the pixel area may be increased or decreased by a percentage of an absolute value of the correction number.

In an embodiment, in case that the correction number is a positive number, the discharge volume of the nozzle corresponding to the pixel area may be increased by a percentage of the absolute value of the correction number.

In an embodiment, in case that the correction number is a negative number, the discharge volume of the nozzle corresponding to the pixel area may be decreased by a percentage of the absolute value of the correction number.

In an embodiment, each of the initial numbers may be an integer greater than or equal to about 0.

In an embodiment, each of the initial numbers may have a spatial frequency in the initial sequence, and a difference in spatial frequency between the initial numbers may be about 10% or less.

In an embodiment, the initial numbers may have a same spatial frequency in the initial sequence.

In an embodiment, in the discharging of droplets to the pixel areas, a driving waveform signal applied to the nozzles may be changed to adjust the discharge volume of the nozzles.

In an embodiment, the driving waveform signal may have a driving section and a non-driving section before and after the driving section, and in the discharging of droplets to the pixel areas, a magnitude of a voltage in the driving section may be changed.

In an embodiment, the driving waveform signal may have a driving section and a non-driving section before and after the driving section, and in the discharging of droplets to the pixel areas, a length of the driving section may be changed.

In an embodiment, the driving waveform signal may have a driving section and a non-driving section before and after the driving section, and in the discharging of droplets to the pixel areas, a frequency of the driving section included in the driving waveform signal may be changed.

In an embodiment, the nozzles may form a nozzle row, and in the discharging of droplets to the pixel areas, the discharge volume of each of the nozzles may be individually adjusted.

An inkjet printing apparatus according to an embodiment includes nozzles that discharge droplets to pixel areas, an input part where a measurement error range for discharge volume of the nozzles is input, a calculation part which generates a correction sequence in which correction numbers are arranged in a matrix from based on a data input to the input part, a waveform generation part which generates a driving waveform signal applied to the nozzles, and an output part which outputs a control signal to the waveform generation part based on the correction sequence.

In an embodiment, a variable range for volume of droplets discharged to the pixel areas may be further input to the input part.

In an embodiment, an initial sequence in which initial numbers corresponding to the pixel areas are arranged in a matrix form may be further input to the input part.

In an embodiment, the calculation part may correct the initial numbers with the correction numbers based on the variable range and the measurement error range.

In an embodiment, the variable range may be about −A % to about +A %, the measurement error range may be about −B % to about +B %, each of A and B may be a positive number, and B may be smaller than A, and the correction numbers may include a number calculated by Equation 1 and a number calculated by Equation 2 below

$$A - B \qquad [ Equation 1 ]$$

$$- ( A - B ) . \qquad [ Equation 2 ]$$

In an embodiment, for remaining numbers other than a maximum value and a minimum value among the initial numbers, in case that C is a ratio of any one remaining number to a difference between the maximum value and the minimum value, the correction numbers may further include a number calculated by Equation 3 below.

$$( A - B ) \times ( 2 C - 1 ) \qquad [ Equation 3 ]$$

In an embodiment, the variable range may be about −A % to about +A %, the measurement error range may be about −B % to about +B %, each of A and B may be a positive number, and B may be smaller than 1, for remaining numbers other than a maximum value and a minimum value among the initial numbers, in case that C is a ratio of any one remaining number to a difference between the maximum value and the minimum value, the correction numbers may include A, −A, and a number calculated by Equation 4 below

$$A \times ( 2 C - 1 ) . \qquad [ Equation 4 ]$$

In an embodiment, the driving waveform signal may have a driving section and a non-driving section before and after the driving section, and the control signal may include at least one of a first control signal which controls a magnitude of a voltage of the driving section, a second control signal which controls a length of the driving section, and a third control signal which controls a frequency of the driving section included in the driving waveform signal.

The inkjet printing method according to embodiments may include the generating an initial sequence in which initial numbers are arranged in a matrix form, the generating a correction sequence by correcting the initial numbers with correction numbers based on a variable range for a volume of droplets ejected into pixel areas and measurement error range for discharge volume of nozzles which discharge droplets to the pixel areas, and the discharging droplets to the pixel areas while adjusting a discharge volume for each nozzle based on the correction sequence.

Accordingly, the discharge volume of the nozzles may be adjusted in advance by considering measurement errors that may occur when measuring the discharge volume of the nozzles by the measuring apparatus, or the like. Accordingly, it is possible to readily correct differences in the discharge volume of each nozzle that are not yet recognized due to measurement errors in the discharge volume of the nozzles.

Accordingly, the discharge volume of the droplet finally discharged to each of the pixel areas by the inkjet printing method according to embodiments may be relatively uniform. That is, a phenomenon in which there is a relative difference in the discharge volume of the droplet discharged to the pixel areas in a specific column among the pixel areas may be prevented. Accordingly, an occurrence of stains such as mura in portions corresponding to pixel areas of a specific column may be prevented. Accordingly, reliability of the inkjet printing process may be improved.

It is to be understood that both the foregoing general description and the following detailed description are explanatory and are intended to provide further explanation of the disclosure as claimed.

### BRIEF DESCRIPTION OF THE DRAWINGS

Illustrative, non-limiting embodiments will be more clearly understood from the following detailed description taken in conjunction with the accompanying drawings.

FIG. 1 is a schematic perspective view illustrating an inkjet printing apparatus according to an embodiment.

FIG. 2 is a schematic view illustrating a head included in the inkjet printing apparatus of FIG. 1.

FIG. 3 is a schematic view illustrating a controller included in the inkjet printing apparatus of FIG. 1.

FIG. 4 is a schematic view illustrating an example of an initial sequence input to the input part of FIG. 3.

FIG. 5 is a schematic view illustrating an example of a correction sequence generated by the calculation part of FIG. 3.

FIG. 6 is a schematic view illustrating an example of a driving waveform signal generated by the waveform generation part of FIG. 3.

FIG. 7 is a schematic view illustrating an example in which discharge volume of droplets discharged to pixel areas is adjusted by a driving waveform signal applied by the control part of FIG. 3.

FIG. 8 is a schematic view illustrating the volume of the droplet discharged to the pixel areas according to the before-discharge volume of FIG. 7.

FIG. 9 is a schematic view illustrating the volume of the droplet discharged to the pixel areas according to the after-discharge volume of FIG. 7.

FIG. 10 is a schematic flowchart illustrating an inkjet printing method using the inkjet printing apparatus of FIG. 1.

### DETAILED DESCRIPTION OF THE EMBODIMENTS

Hereinafter, embodiments of the disclosure will be described in more detail with reference to the attached drawings. The same reference numerals and/or characters will be used for the same components in the drawings, and duplicate descriptions of the same components may be omitted.

The term “about” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

The term “and/or” includes all combinations of one or more of which associated configurations may define. For example, “A and/or B” may be understood to mean “A, B, or A and B.”

For the purposes of this disclosure, the phrase “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

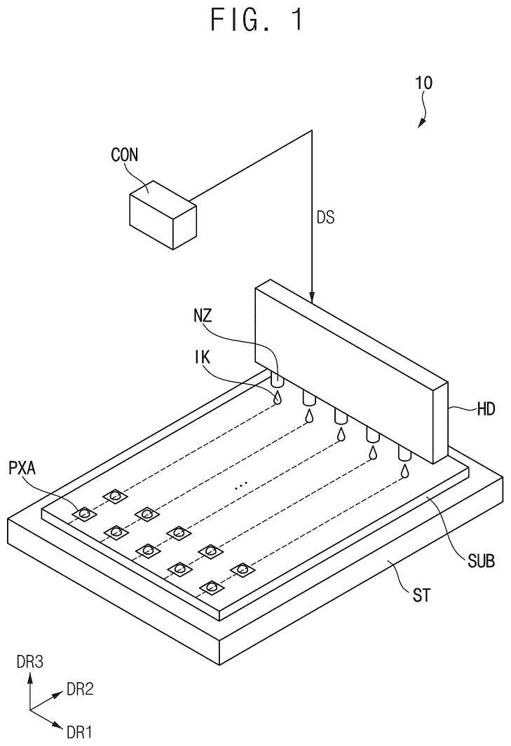

FIG. 1 is a schematic perspective view illustrating an inkjet printing apparatus according to an embodiment.

Referring to FIG. 1, the inkjet printing apparatus 10 may include a head HD and a controller CON. The inkjet printing apparatus 10 may be located on a stage ST.

The stage ST may be parallel to a plane defined by a first direction DR1 and a second direction DR2 that intersects the first direction DR1. For example, the first direction DR1 and the second direction DR2 may be perpendicular to each other.

The stage ST may support a target substrate SUB. A droplet IK may be deposited on the target substrate SUB to form a pattern.

The head HD may be spaced apart from the stage ST in a third direction DR3 that intersects each of the first direction DR1 and the second direction DR2. For example, the third direction DR3 may be perpendicular to each of the first direction DR1 and the second direction DR2.

The head HD may discharge the droplet IK to the target substrate SUB disposed on the stage ST. The head HD may include one or more nozzles NZ that discharge the droplet IK to the target substrate SUB in a direction opposite to the third direction DR3. For example, the nozzles NZ may be arranged in the first direction DR1.

The head HD may move in the second direction DR2. The head HD may move in the second direction DR2 and/or discharge the droplet IK to the target substrate SUB. For example, the head HD may discharge the droplet IK in a stationary state, then move a distance (e.g., a predetermined or selectable distance) in the second direction DR2 and discharge the droplet IK again in a stationary state. However, the disclosure is not limited thereto, and the head HD may move and repeatedly discharge the droplets IK. The stage ST may move in the second direction DR2 and/or the head HD may discharge the liquid droplet IK in a stationary state.

Pixel areas PXA may be defined on the target substrate SUB. For example, the pixel areas PXA may be arranged in a matrix form in the first direction DR1 and the second direction DR2. The pixel areas PXA may be a space that accommodates the droplet IK discharged from the head HD. For example, the head HD may move in the second direction DR2 and discharge the droplet IK to the pixel areas PXA.

The droplet IK discharged to the target substrate SUB may be hardened to form the pattern. For example, the pattern may be formed in the pixel areas PXA. For example, the droplet IK discharged from the head HD may form the pattern in the first direction DR1 and the second direction DR2.

The controller CON may control a driving of the head HD. The controller CON may apply (or output) a driving waveform signal DS to the head HD. The driving waveform signal DS may include information about an ejection of the droplet IK. The head HD may be driven in response to the driving waveform signal DS.

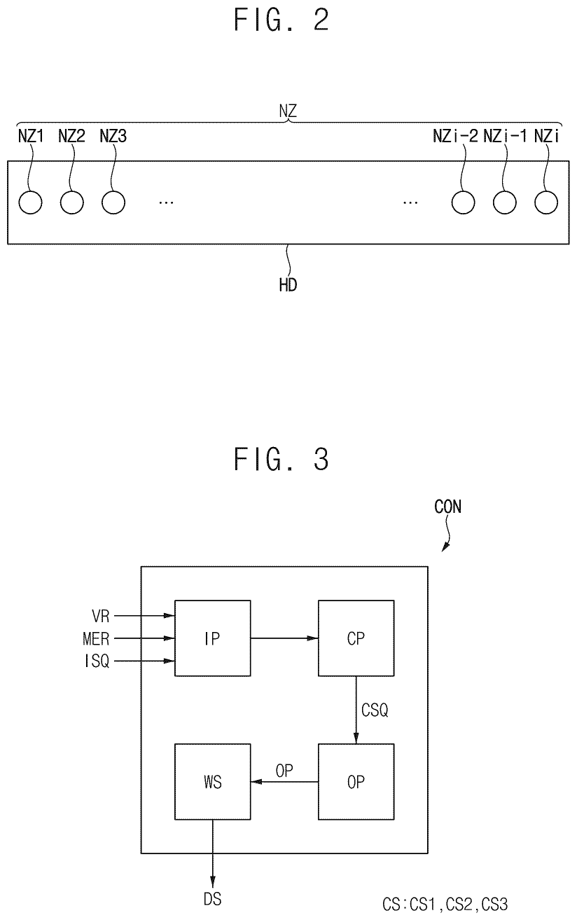

FIG. 2 is a schematic view illustrating a head included in the inkjet printing apparatus of FIG. 1.

Referring to FIGS. 1 and 2, the head HD may include the nozzles NZ. For example, the head HD may include first to i-th (where i is a natural number) nozzles NZ1, . . . , NZi. Each of the first to i-th nozzles NZ1, . . . , NZi may discharge the droplet IK.

In an embodiment, a discharge volume of the droplet IK discharged from each of the first to i-th nozzles NZ1, . . . , NZi may be individually adjusted. For example, the controller CON may individually adjust the discharge volume of the droplet IK for each of the first to i-th nozzles NZ1, . . . , NZi. Hereinafter, for convenience of explanation, the discharge volume of the droplet IK is simply referred to as the discharge volume.

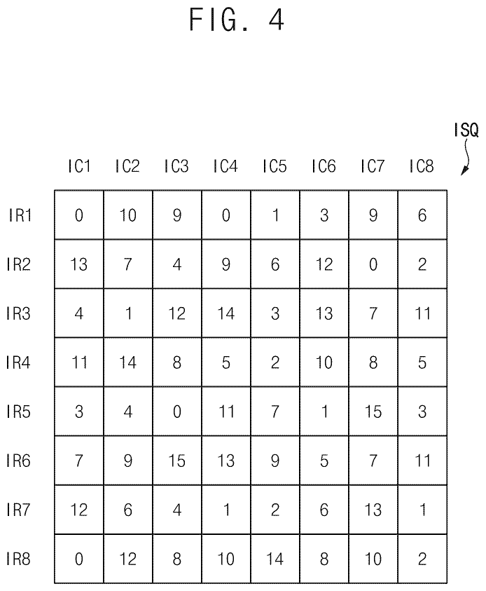

FIG. 3 is a schematic view illustrating a controller included in the inkjet printing apparatus of FIG. 1.

Referring to FIGS. 1 and 3, the controller CON may include an input part IP, a calculation part CP, a waveform generation part WS, and/or an output part OP.

Various data related to an inkjet printing process using the inkjet printing apparatus 10 may be input to the input part IP.

A variable range VR for volume of the droplet IK discharged to the pixel areas PXA may be input to the input part IP. The variable range VR may mean an allowable range for a difference in a volume of the droplet IK actually discharged with respect to a target volume of the droplet IK to be discharged to each of the pixel areas PXA. For example, the variable range VR may be about −A % to about +A %. Here, A may be a positive number.

Information measuring the discharge volume of the nozzles NZ by a measuring apparatus or the like may be input to the input part IP. A measurement error range MER that may occur when measuring the discharge volume of the nozzles NZ by the measuring apparatus or the like may be input to the input part IP. The measurement error range MER may mean an allowable range of measurement errors that may occur due to various factors (temperature, pressure, discharge surface characteristics, etc.) when measuring the discharge volume of each of the nozzles NZ by the measuring device or the like. For example, the measurement error range MER may be about −B % to about +B %. Here, B may be a positive number. In an embodiment, B may be smaller than A.

An initial sequence ISQ in which initial numbers corresponding to the pixel areas PXA are arranged in a matrix form may be input to the input part IP. Each of the initial numbers may be an integer greater than or equal to about 0.

The initial sequence ISQ may be a sequence generated by considering spatial frequency. Specifically, each of the initial numbers may have a spatial frequency in the initial sequence ISQ, and a difference in spatial frequency between the initial numbers may be about 10% or less.

For example, the initial sequence ISQ may be a sequence in which the initial numbers are arranged with relatively uniform spatial frequencies to prevent local changes in spatial frequency.

Specifically, in the initial sequence ISQ, the number of initial numbers with the same absolute value among the initial numbers may be the same or similar for each absolute value. For example, in the initial sequence ISQ, in case that an initial number having a first absolute value and an initial number having a second absolute value are randomly selected, a difference between the number of initial numbers having the first absolute value and the number of initial numbers having the second absolute value may be about 10% or less. For example, in case that the number of initial numbers having the first absolute value is about 20, the number of initial numbers having the second absolute value may be about 18 to about 22. However, the disclosure is not necessarily limited thereto, and in the initial sequence ISQ, a distribution of the initial numbers may be changed in various ways.

In an embodiment, various algorithms may be adopted to generate the initial sequence ISQ. An error distribution method may be adopted as an algorithm for generating the initial sequence ISQ. For example, FM mask methods may be used as an algorithm for generating the initial sequence ISQ. Specifically, VOID AND CLUSTER rule among the FM mask methods may be used. For example, the initial sequence ISQ may be generated by performing the VOID AND CLUSTER rule multiple times. However, the disclosure is not limited thereto, and the initial sequence ISQ may be generated in various ways.

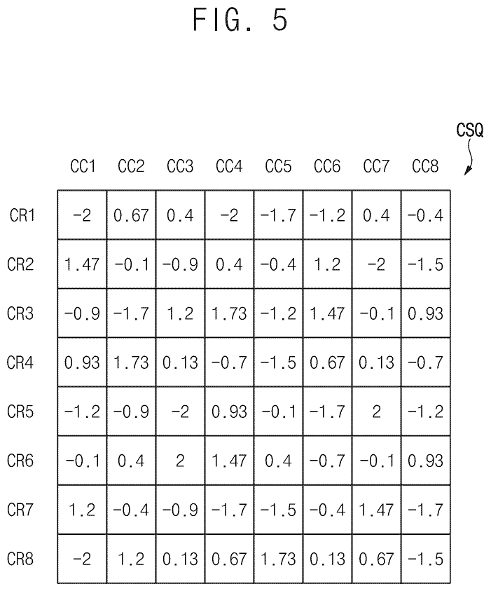

FIG. 4 is a schematic view illustrating an example of an initial sequence input to the input part of FIG. 3.

In FIG. 4, the initial sequence ISQ in which a total of 64 initial numbers are arranged in a matrix form, with 8 rows IR1, IR2, . . . , IR8 and 8 columns IC1, IC2, . . . , IC8 is illustrated as an example. The minimum value among the initial numbers is 0 and the maximum value among the initial numbers is 15 in FIG. 4. However, the disclosure is not necessarily limited thereto, and the number of initial numbers, the number of rows, and the number of columns of the initial sequence ISQ may vary depending on embodiments. The minimum value and the maximum value (i.e., a combination of the initial numbers) may vary depending on embodiments.

Referring again to FIGS. 1 and 3, the calculation part CP may generate a correction sequence CSQ based on the data input to the input part IP. For example, the calculation part CP may generate the correction sequence CSQ based on the variable range VR, the measurement error range MER, and the initial sequence ISQ input to the input part IP. The correction sequence CSQ may be a sequence in which correction numbers are arranged in a matrix form. The correction numbers may be numbers obtained by correcting the initial numbers based on the variable range VR, the measurement error range MER, and/or the initial sequence ISQ.

A calculation method by which the calculation part CP generates the correction sequence CSQ from the initial sequence ISQ may be as follows.

As described above, the variable range VR input to the input part IP may be −A % to +A %, and the measurement error range MER input to the input part IP may be −B % to +B %.

In this case, the calculation part CP may correct the maximum value among the initial numbers in the initial sequence ISQ to a number calculated by Equation 1.

$$A - B \qquad [ Equation 1 ]$$

The calculation part CP may correct the minimum value among the initial numbers in the initial sequence ISQ to a number calculated by Equation 2.

$$- ( A - B ) \qquad [ Equation 2 ]$$

For remaining numbers other than the maximum value and the minimum value among the initial numbers, the calculation part CP may correct each of the remaining numbers to a number located at a point between about −(A−B) and about +(A−B) corresponding to a point where each of the remaining numbers is located between the maximum value and the minimum value.

For example, in case that a ratio of any one remaining number to a difference between the maximum value and the minimum value is about C, the calculation part CP may correct the remaining number to a number calculated by Equation 3.

$$( A - B ) \times ( 2 C - 1 ) \qquad [ Equation 3 ]$$

As a result, in case that the variable range VR input to the input part IP is about −A % to about +A %, the measurement error range MER input to the input part IP is about −B % to about +B %, and C is a ratio of any one remaining number to a difference between the maximum value and the minimum value of the initial numbers, the correction numbers of the correction sequence CSQ generated by the calculation part CP may include the number calculated by Equation 1, the number calculated by Equation 2, and the number calculated by Equation 3.

FIG. 5 is a schematic view illustrating an example of a correction sequence generated by the calculation part of FIG. 3.

With reference to FIGS. 4 and 5, a principle of generating the correction sequence CSQ by the calculation part CP will be described as an example.

For example, the correction sequence CSQ of FIG. 5 may be a sequence generated by the correction part based on a sequence ISQ of FIG. 4 in case that the variable range VR is about −3% to about +3% and the measurement error range is about −1% to about +1%. For example, in FIG. 5, the correction sequence CSQ in which a total of 64 correction numbers are arranged in a matrix form, with 8 rows CR1, CR2, . . . , CR8 and 8 columns CC1, CC2, . . . , CC8 illustrated as an example.

In this case, the calculation part CP may correct the maximum value of 15 among the initial numbers to a correction number of 2 (e.g., 3−1) according to the Equation 1. The calculation part CP may correct the minimum value of 0 among the initial numbers to a correction number of −2 (e.g., −(3−1)) according to the Equation 2. The calculation part CP may correct remaining numbers other than the maximum value of 15 and the minimum value of 0 (e.g., initial numbers from 1 to 14) according to the Equation 3. To explain a method of correcting a remaining number of 10 as an example, a ratio of the remaining number of 10 to 15, which is a difference between the maximum value and the minimum value, is 10/15, so as 10/15 is substituted into C in the Equation 3, the remaining number 10 may be corrected to a correction number of about 0.67. To explain a method of correcting a remaining number of 3 as an example, a ratio of the remaining number of 3 to 15, which is the difference between the maximum value and the minimum value, is 3/15, so as 3/15 is substituted into C in the Equation 3, the remaining number of 3 may be corrected to a correction number of about −1.2.

As a result, the correction sequence CSQ generated by the calculation part CP based on the initial sequence ISQ of FIG. 4 may be a sequence in which multiple correction numbers from −2 to 2 are arranged in a matrix form.

In an embodiment, in case that the measurement error range MER is a negligible small range (for example, in case that B is less than 1), the calculation part CP may correct the maximum value among the initial numbers in the initial sequence ISQ to A, correct the minimum value among the initial numbers in the initial sequence ISQ to −A, and may correct the remaining numbers among the initial numbers to a number calculated by Equation 4.

$$A \times ( 2 C - 1 ) \qquad [ Equation 4 ]$$

For example, in case that the measurement error range MER is a negligible small range, the calculation part CP may generate the correction sequence CSQ by considering only the variable range VR and not considering the measurement error range MER.

Referring again to FIGS. 1 and 3, the waveform generation part WS may generate the driving waveform signal DS applied to the head HD (e.g., the nozzles NZ).

In an embodiment, the driving waveform signal DS may include one or more driving waveform signals respectively applied to the nozzles NZ. For example, the waveform generation part WS may generate first to i-th driving waveform signals that control whether or not droplets are discharged and the discharge volume of each of the first to i-th nozzles NZ1, . . . , NZi. The first to i-th driving waveform signals may correspond one-to-one with the first to i-th nozzles NZ1, . . . , NZi.

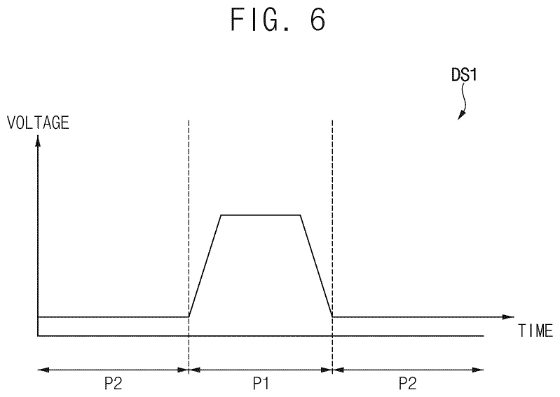

FIG. 6 is a schematic view illustrating an example of a driving waveform signal generated by the waveform generation part of FIG. 3.

In FIG. 6, for convenience of explanation, only a first driving waveform signal DS1 among the first to i-th driving waveform signals is selectively illustrated. The second to i-th driving waveform signals may have a substantially similar form to the first driving waveform signal DS1.

Referring further to FIG. 6, the first driving waveform signal DS1 may have a driving section P1 and a non-driving section P2 before and after the driving section P1. The driving section P1 may include a rising section, a maintaining section, and a falling section. The driving section P1 may be a section in which the first nozzle NZ1, which has received the first driving waveform signal DS1, is driven to discharge the droplet IK. The non-driving section P2 may be a section in which the first nozzle NZ1 is not driven.

By changing a magnitude of a voltage of the driving section P1, a length of the driving section P1 and/or the non-driving section P2, a frequency of the driving section P1 included in one driving waveform signal, or the like, whether or not the nozzle receiving the driving waveform signal discharges droplets, the discharge volume, or the like may be adjusted. For example, in order to control whether or not the droplet is discharged and the discharge volume of each of the first to i-th nozzles NZ1, . . . , NZi, the magnitude of the voltage in the driving section of each of the first to i-th driving waveform signals, the length of the driving section, the frequency of the driving section, or the like may be changed.

For example, by changing the magnitude of the voltage of the driving section of the first driving waveform signal DS1, the length of the driving section, the frequency of the driving section, or the like, whether or not the first nozzle NZ1 discharges droplets, the discharge volume, or the like may be adjusted. Similarly, by changing the magnitude of the voltage of the driving section of the second driving waveform signal, the length of the driving section, the frequency of the driving section, or the like, whether or not the second nozzle NZ1 discharges droplets, the discharge volume, or the like may be adjusted. By the same principle, whether or not each of the third to i-th nozzles (NZ3, . . . , NZi) discharges droplets and the discharge volume of droplets may be adjusted.

The output part OP may change the driving waveform signal DS. For example, the output part OP may output a control signal CS that changes the driving waveform signal DS. The output part OP may apply the control signal CS to the waveform generation part WS.

In case that adjustment of whether or not to discharge droplets or discharge volume of each of the first to i-th nozzles NZ1, . . . , NZi is required, the control signal CS output from the output part OP may be transmitted to the waveform generation part WS. Accordingly, the driving waveform signal DS (for example, at least one of the first to i-th driving waveform signals) may be changed. For example, the control signal CS may change a magnitude of a voltage of at least one driving section among the first to i-th driving waveform signals, a length of the driving section, a frequency of the driving section, or the like.

Specifically, the output part OP may receive the correction sequence CSQ from the calculation part CP and output the control signal CS based on the correction sequence CSQ.

The output part OP may correspond to the correction numbers in the correction sequence CSQ to the pixel areas PXA. If the number of rows and columns of the correction sequence CSQ is smaller than the number of rows and columns of the matrix of the pixel areas PXA, the correction numbers may correspond to the pixel areas PXA by repeatedly arranging the correction sequence CSQ.

A correction number corresponding to a pixel area among the pixel areas PXA may be recognized as a degree to which a discharge volume of a nozzle corresponding to the pixel area need to be adjusted. In other words, the discharge volume of the nozzle corresponding to the pixel area may be adjusted based on the correction number corresponding.

For example, in case that the correction number corresponding to the pixel area is a positive number, the output part OP may output the control signal CS to increase the discharge volume of the nozzle corresponding to the pixel area by a percentage of the absolute value of the correction number.

For example, in case that the correction number corresponding to the pixel area is a positive number, in response to the control signal CS output by the output part OP, the waveform generation part WS may generate a driving waveform signal changed so that the discharge volume of the nozzle increases by a percentage of the absolute value of the correction number, and apply the driving waveform signal which is changed to the nozzle.

For example, in case that the correction number corresponding to the pixel area is a negative number, the output part OP may output the control signal CS to decrease the discharge volume of the nozzle corresponding to the pixel area by a percentage of the absolute value of the correction number.

For example, in case that the correction number corresponding to the pixel area is a negative number, in response to the control signal CS output by the output part OP, the waveform generation part WS may generate a driving waveform signal changed so that the discharge volume of the nozzle decreases by a percentage of the absolute value of the correction number, and apply the driving waveform signal which is changed to the nozzle.

In an embodiment, the control signal CS may include a first control signal CS1 which controls a magnitude of a voltage of the driving section P1. For example, the first control signal CS1 may increase a magnitude of a voltage in the driving section of the driving waveform signal applied to the nozzle for which an increase in discharge volume is required. The first control signal CS1 may reduce a magnitude of a voltage in the driving section of the driving waveform signal applied to the nozzle for which a decrease in discharge volume is required. However, the disclosure is not necessarily limited thereto.

In an embodiment, the control signal CS may include a second control signal CS2 which controls a length of the driving section P1. For example, the second control signal CS2 may extend a length of the driving section of the driving waveform signal applied to the nozzle for which an increase in discharge volume is required. The second control signal CS2 may shorten a length of the driving section of the driving waveform signal applied to the nozzle for which a decrease in discharge volume is required. However, the disclosure is not necessarily limited thereto.

In an embodiment, the control signal CS may include a third control signal CS3 which controls a frequency of the driving section P1. For example, the third control signal CS3 may increase a frequency of the driving section of the driving waveform signal applied to the nozzle that requires an increase in discharge volume. The third control signal CS3 may reduce a frequency of the driving section of the driving waveform signal applied to the nozzle requiring a decrease in discharge volume. However, the disclosure is not necessarily limited thereto.

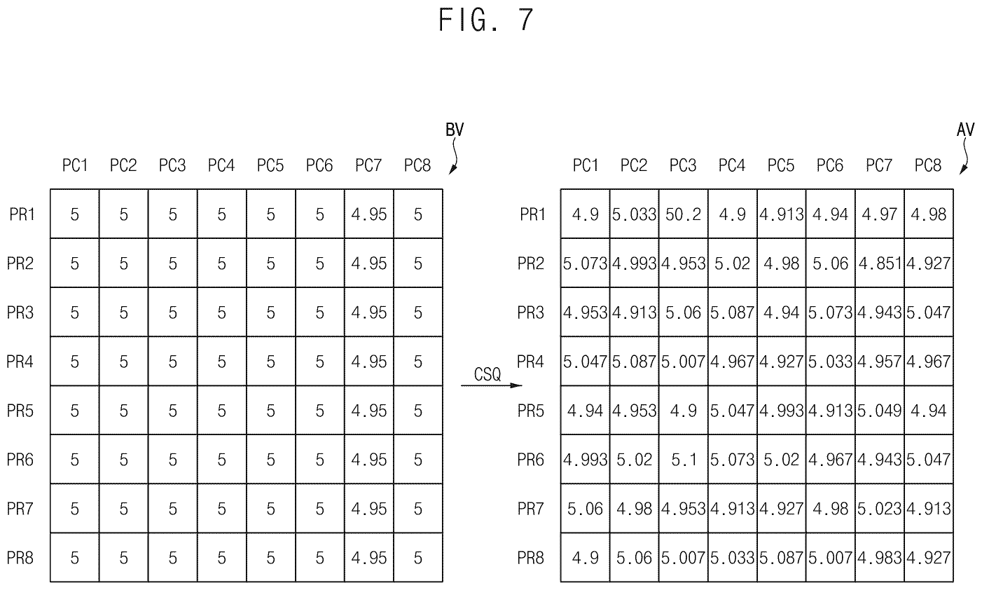

FIG. 7 is a schematic view illustrating an example in which discharge volume of droplets discharged to pixel areas is adjusted by a driving waveform signal applied by the control part of FIG. 3.

For example, FIG. 7 is a schematic view illustrating an example in which the discharge volume of the nozzles NZ corresponding to the pixel areas PXA is adjusted by the driving wavelength signal DS applied by the waveform generation part WS in response to the control signal CS output by the output part OP based on the correction sequence CSQ of FIG. 5.

With further reference to FIG. 7, a principle by which the discharge volume of the droplet IK is controlled by the controller CON will be explained as an example.

For convenience of explanation, an example in which the pixel areas PXA have 8 rows PR1, PR2, . . . , PR8 and 8 columns PC1, PC2, . . . , PC8, 8 rows PR1, PR2, . . . , PR8 of the pixel areas PXA correspond to 8 rows CR1, CR2, . . . , CR8 of the correction sequence CSQ of FIG. 5, respectively, and 8 columns PC1, PC2, . . . , PC8 of the pixel areas PXA correspond to 8 columns CC1, CC2, . . . , CC8 of the correction sequence CSQ of FIG. 5, respectively is illustrated in FIG. 7. However, as described above, the disclosure is not necessarily limited thereto, and the number of rows and columns of the correction sequence CSQ may be smaller than the number of rows and columns of the pixel areas PXA. In this case, by repeatedly arranging the correction sequence CSQ, the correction numbers may correspond to the pixel areas PXA.

FIG. 7 illustrates a before-discharge volume BV which represents discharge volume of nozzles corresponding to the pixel areas PXA before adjustment based on the correction sequence CSQ and after-discharge volume AV which represents discharge volume of nozzles corresponding to the pixel areas PXA after adjustment based on the correction sequence CSQ. Unit of each of the before-discharge volume BV and after-discharge volume AV is picoliter (pL).

For example, in the before-discharge volume BV, a discharge volume of a nozzle corresponding to the pixel areas located in the seventh column PC7 among the pixel areas PXA before being adjusted based on the correction sequence CSQ may be about 4.95 pL, and discharge volume of the nozzles corresponding to remaining pixel areas may be about 5 pL.

Taking the discharge volume of the nozzle corresponding to the pixel area in the first row PR1 and first column PC1 among the pixel areas PXA as an example, the before-discharge volume, about 5 pL, may be decreased by a percentage (e.g. about 0.02%) of the absolute value of the correction number −2 (the correction number in the first row CR1 and first column CC1 of the correction sequence CSQ) and be adjusted to about 4.9 pL. For example, in the after-discharge volume AV, the discharge volume corresponding to the pixel area of the first row PR1 and the first column PC1 among the pixel areas PXA may be 4.9 pL.

Taking the discharge volume of the nozzle corresponding to the pixel area in the fifth row PR5 and seventh column PC7 among the pixel areas PXA as an example, the before-discharge volume, about 4.95 pL, may be increased by a percentage (e.g. about 0.02%) of the absolute value of the correction number 2 (the correction number in the fifth row CR5 and seventh column CC7 of the correction sequence CSQ) and be adjusted to about 5.049 pL. For example, in the after-discharge volume AV, the discharge volume corresponding to the pixel area of the fifth row PR5 and the seventh column PC7 among the pixel areas PXA may be about 5.049 pL.

Taking the discharge volume of the nozzle corresponding to the pixel area in the first row PR1 and second column PC2 among the pixel areas PXA as an example, the before-discharge volume, about 5 pL, may be increased by a percentage (e.g. about 0.0067%) of the absolute value of the correction number 0.67 (the correction number in the first row CR1 and second column CC2 of the correction sequence CSQ) and be adjusted to about 5.033 pL. For example, in the after-discharge volume AV, the discharge volume corresponding to the pixel area of the first row PR1 and the second column PC2 among the pixel areas PXA may be about 5.033 pL.

Taking the discharge volume of the nozzle corresponding to the pixel area in the first row PR1 and sixth column PC6 among the pixel areas PXA as an example, the before-discharge volume, about 5 pL, may be decreased by a percentage (e.g. about 0.012%) of the absolute value of the correction number about −1.2 (the correction number in the first row CR1 and sixth column CC6 of the correction sequence CSQ) and be adjusted to about 4.94 pL. For example, in the after-discharge volume AV, the discharge volume corresponding to the pixel area of the first row PR1 and the sixth column PC6 among the pixel areas PXA may be about 4.94 pL.

In this way, the controller CON can adjust the discharge volume of the nozzles NZ corresponding to the pixel areas PXA. Accordingly, the discharge volume of the nozzles NZ corresponding to the pixel areas PXA may be expressed as the after-discharge volume AV.

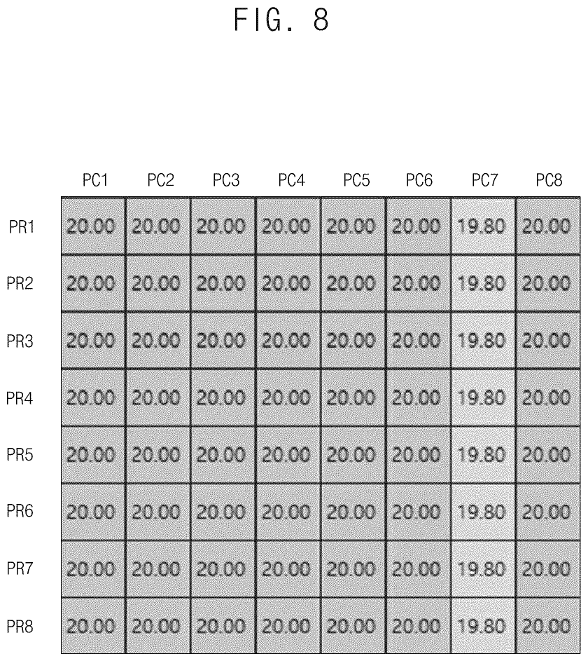

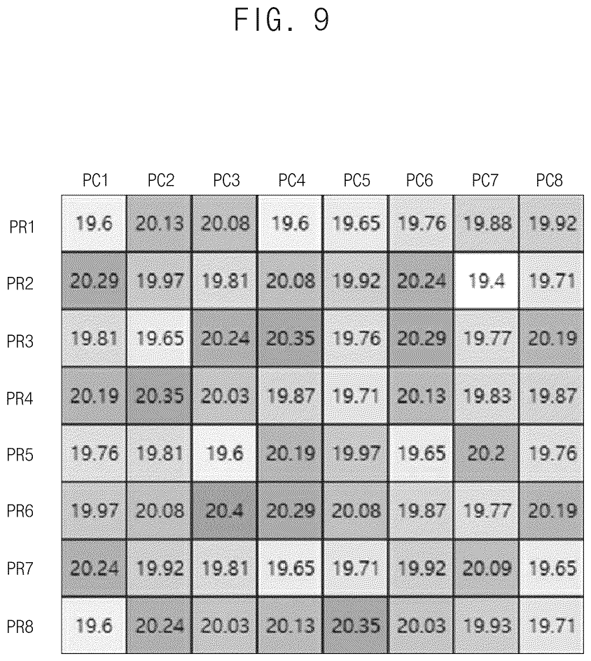

FIG. 8 is a schematic view illustrating the volume of the droplet discharged to the pixel areas according to the before-discharge volume of FIG. 7. FIG. 9 is a schematic view illustrating the volume of the droplet discharged to the pixel areas according to the after-discharge volume of FIG. 7.

First, referring to FIGS. 7 and 8, in the before-discharge volume BV, the discharge volume of the nozzle corresponding to the pixel areas located in the seventh column PC7 among the pixel areas PXA may be about 4.95 pL, and the discharge amount of the nozzle corresponding to the pixel areas PXA remaining may be about 5 pL. If a total of four drops of the droplet IK are discharged in a pixel area, as shown in FIG. 8, the discharge volume of the droplet finally discharged to each of the pixel areas located in the seventh column PC7 may be about 19.80 pL, and the discharge volume of the droplet finally discharged to each of the remaining pixel areas may be about 20.00 pL. In this case, stains such as mura may occur in portions corresponding to the pixel areas of the seventh column PC7 due to a relative difference in discharge volume. In particular, in the before-discharge volume BV, the inkjet process may be performed without a difference in discharge volume for each nozzle being recognized due to errors that occur when measuring the discharge volume of the nozzles NZ by the measuring apparatus of the like. Therefore, it is desirable to prevent an occurrence of stains by adjusting the discharge volume of the nozzles NZ in advance by considering an error range that may occur when measuring the discharge volume of the nozzles NZ.

Referring further to FIG. 9, according to embodiments, the discharge volume of the nozzles NZ may be adjusted based on the variable range (VR, in FIG. 3), the measurement error range (MER, in FIG. 3), and the correction sequence (CSQ, in FIGS. 3 and 5) generated based on the initial sequence (ISQ, in FIGS. 3 and 4). Accordingly, based on the after-discharge amount AV, the discharge volume of the droplet finally discharged to each of the pixel areas PXA may be relatively uniform. For example, a phenomenon in which there is a relative difference in the discharge volume of the droplet discharged to the pixel areas in a specific column among the pixel areas PXA may be prevented. Accordingly, an occurrence of stains such as mura in portions corresponding to pixel areas of a specific column may be prevented.

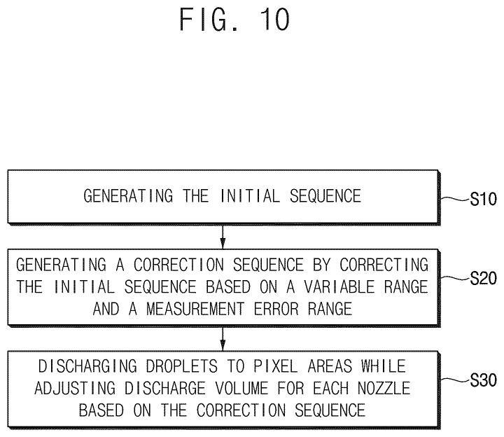

FIG. 10 is a schematic flowchart illustrating an inkjet printing method using the inkjet printing apparatus of FIG. 1.

Hereinafter, with reference to FIG. 10, an inkjet printing method using the inkjet printing apparatus of FIG. 1 will be briefly described. Descriptions that overlap with descriptions referring to FIGS. 1 to 9 may be omitted or simplified.

Referring to FIGS. 1, 3, and 10, the inkjet printing method according to an embodiment may include generating an initial sequence ISQ S10, generating a correction sequence CSQ by correcting the initial sequence ISQ based on a variable range VR and a measurement error range MER S20, and discharging droplets IK to pixel areas PXA while adjusting discharge volume for each nozzle NZ based on the correction sequence CSQ S30.

In the generating of the initial sequence ISQ S10, the initial sequence ISQ may be generated by arranging the initial numbers in a matrix form. The initial sequence ISQ may be generated considering spatial frequency. Specifically, in the initial sequence ISQ, the number of initial numbers with the same absolute value among the initial numbers may be the same or similar for each absolute value. In an embodiment, the initial sequence ISQ may be generated using an error distribution algorithm. For example, the FM mask methods may be used as an algorithm for generating the initial sequence ISQ.

In the generating of the correction sequence CSQ S20, the variable range VR, the measurement error range MER, and the initial sequence ISQ may be input to the input part IP. Thereafter, the calculation part CP may be used to generate the correction sequence CSQ based on the variable range VR, the measurement error range MER, and the initial sequence ISQ.

In the generating of the correction sequence CSQ S20, the variable range VR input to the input part IP may be −A % to +A %, and the measurement error range MER input to the input part IP may be −B % to +B %.

In the generating of the correction sequence CSQ, the calculation part CP may correct the maximum value among the initial numbers in the initial sequence ISQ to a number calculated by the Equation 1.

$$A - B \qquad [ Equation 1 ]$$

The calculation part CP may correct the minimum value among the initial numbers in the initial sequence ISQ to a number calculated by Equation 2.

$$- ( A - B ) \qquad [ Equation 2 ]$$

For remaining numbers other than the maximum value and the minimum value among the initial numbers, the calculation part CP may correct each of the remaining numbers to a number located at a point between −(A−B) and +(A−B) corresponding to a point where each of the remaining numbers is located between the maximum value and the minimum value.

For example, in case that a ratio of any one remaining number to a difference between the maximum value and the minimum value is C, the calculation part CP may correct the remaining number to a number calculated by Equation 3.

$$( A - B ) \times ( 2 C - 1 ) \qquad [ Equation 3 ]$$

As a result, the correction numbers of the correction sequence CSQ generated in the generating of the correction sequence CSQ S20 may include the number calculated by Equation 1, the number calculated by Equation 2, and the number calculated by Equation 3.

In an embodiment, in case that the measurement error range MER is a negligible small range (for example, in case that B is less than 1), in the generating of the correction sequence CSQ S20, the calculation part CP may correct the maximum value among the initial numbers in the initial sequence ISQ to A, may correct the minimum value among the initial numbers in the initial sequence ISQ to −A, and may correct the remaining numbers among the initial numbers to a number calculated by Equation 4.

$$A \times ( 2 C - 1 ) \qquad [ Equation 4 ]$$

For example, in case that the measurement error range MER is a negligible small range, the calculation part CP may generate the correction sequence CSQ by considering only the variable range VR and not considering the measurement error range MER.

In the discharging of the droplets IK to the pixel areas PXA S30, the discharge volume for each nozzle NZ may be adjusted based on the correction sequence CSQ.

First, the correction numbers in the correction sequence CSQ may correspond to the pixel areas PXA. If the number of rows and columns of the correction sequence CSQ may be smaller than the number of rows and columns of the pixel areas PXA, the correction numbers may correspond to the pixel areas PXA by repeatedly arranging the correction sequence CSQ.

Thereafter, a discharge volume of a nozzle corresponding to a pixel area among the pixel areas PXA may be adjusted based on a correction number corresponding. For example, in case that the correction number is a positive number, the discharge volume of the nozzle corresponding to the pixel area may be increased by a percentage of the absolute value of the correction number corresponding. For example, in case that the correction number is a negative number, the discharge volume of the nozzle corresponding to the pixel area may be decreased by a percentage of the absolute value of the correction number corresponding.

At this time, by changing the driving waveform signal applied to the nozzle whose discharge volume is required to be adjusted, the discharge volume of the nozzle may be adjusted.

Specifically, the correction sequence CSQ may be transmitted to the output part OP, and the control signal CS may be output based on the correction sequence CSQ by the output part OP. The driving waveform signal which is changed may be generated by the waveform generation part WS which has received the control signal CS, and the driving waveform signal which is changed may be applied to the nozzle whose discharge volume is required to be adjusted.

In an embodiment, in the process of adjusting the discharge volume for each nozzle NZ, a magnitude of a voltage in the driving section of the driving waveform signal applied to the nozzle for which adjustment of the discharge amount is required may be changed. For example, a magnitude of a voltage in the driving section of the driving waveform signal applied to the nozzle for which an increase in discharge volume is required may be increased. It is possible to decrease a magnitude of a voltage in the driving section of the driving waveform signal applied to the nozzle for which a decrease in discharge volume is required. However, the disclosure is not necessarily limited thereto.

In an embodiment, in the process of adjusting the discharge volume for each nozzle NZ, a length of driving section of the driving waveform signal applied to the nozzle for which adjustment of the discharge amount is required may be changed. For example, a length of the driving section of the driving waveform signal applied to the nozzle for which an increase in discharge volume is required may be extended. It is possible to shorten a length of the driving section of the driving waveform signal applied to the nozzle for which a decrease in discharge volume is required. However, the disclosure is not necessarily limited thereto.

In an embodiment, in the process of adjusting the discharge volume for each nozzle NZ, a frequency of driving section of the driving waveform signal applied to the nozzle for which adjustment of the discharge amount is required may be changed. For example, a frequency of the driving section of the driving waveform signal applied to the nozzle for which an increase in discharge volume is required may be increased. It is possible to decrease a frequency of the driving section of the driving waveform signal applied to the nozzle for which a decrease in discharge volume is required. However, the disclosure is not necessarily limited thereto.

According to the inkjet printing method according to embodiments, the discharge volume of the nozzles NZ may be adjusted in advance by considering measurement errors that may occur when measuring the discharge volume of the nozzles NZ by the measuring apparatus, or the like. Accordingly, it is possible to readily correct differences in the discharge volume of each nozzle that are not yet recognized due to measurement errors in the discharge volume of the nozzles NZ.

Accordingly, the discharge volume of the droplet finally discharged to each of the pixel areas PXA by the inkjet printing method according to embodiments may be relatively uniform. For example, a phenomenon in which there is a relative difference in the discharge volume of the droplet discharged to the pixel areas in a specific column among the pixel areas PXA may be prevented. Accordingly, an occurrence of stains such as mura in portions corresponding to pixel areas of a specific column may be prevented. Accordingly, reliability of the inkjet printing process may be improved.

The disclosure can be applied to a display panel inspection device of various display devices. For example, the disclosure is applicable to a display panel inspection device of various display devices such as display devices for vehicles, ships and aircraft, portable communication devices, display devices for exhibition or information transmission, medical display devices, and the like.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. An inkjet printing method comprising:
generating an initial sequence in which initial numbers are arranged in a matrix form;
generating a correction sequence by correcting the initial numbers with correction numbers based on a variable range for a volume of droplets ejected into pixel areas and a measurement error range for discharge volume of nozzles which discharge droplets to the pixel areas; and
discharging droplets to the pixel areas while adjusting a discharge volume for each nozzle based on the correction sequence.

2. The inkjet printing method of claim 1, wherein
the variable range is about −A % to about +A %, the measurement error range is about −B % to about +B %, each of A and B is a positive number, and B is smaller than A, and
in the generating of the correction sequence, a maximum value among the initial numbers is corrected to a number calculated by Equation 1 below:
$$A - B . \qquad [ Equation 1 ]$$

3. The inkjet printing method of claim 2, wherein in the generating of the correction sequence, a minimum value among the initial numbers is corrected to a number calculated by Equation 2 below
$$- ( A - B ) . \qquad [ Equation 2 ]$$

4. The inkjet printing method of claim 3, wherein, for remaining numbers other than the maximum value and the minimum value among the initial numbers, in case that C is a ratio of any one remaining number to a difference between the maximum value and the minimum value, in the generating of the correction sequence, the remaining number is corrected to a number calculated by Equation 3 below:
$$( A - B ) \times ( 2 C - 1 ) . \qquad [ Equation 3 ]$$

5. The inkjet printing method of claim 1, wherein
the variable range is about −A % to about +A %, the measurement error range is about −B % to about +B %, each of A and B is a positive number, and B is smaller than A,
in the generating of the correction sequence, a maximum value among the initial numbers is corrected to A, and a minimum value among the initial numbers is corrected to −A, and
for remaining numbers other than the maximum value and the minimum value among the initial numbers, in case that C is a ratio of any one remaining number to a difference between the maximum value and the minimum value, in the generating of the correction sequence, the remaining number is corrected to a number calculated by Equation 4 below:
$$A \times ( 2 C - 1 ) . \qquad [ Equation 4 ]$$

6. The inkjet printing method of claim 1, wherein in the discharging of droplets to the pixel areas, the correction numbers correspond to the pixel areas.

7. The inkjet printing method of claim 6, wherein in the discharging of droplets to the pixel areas, a discharge volume of a nozzle corresponding to a pixel area among the pixel areas is adjusted based on a correction number corresponding to the pixel area.

8. The inkjet printing method of claim 7, wherein the discharge volume of the nozzle corresponding to the pixel area is increased or decreased by a percentage of an absolute value of the correction number.

9. The inkjet printing method of claim 8, wherein in case that the correction number is a positive number, the discharge volume of the nozzle corresponding to the pixel area is increased by a percentage of the absolute value of the correction number.

10. The inkjet printing method of claim 8, wherein in case that the correction number is a negative number, the discharge volume of the nozzle corresponding to the pixel area is decreased by a percentage of the absolute value of the correction number.

11. The inkjet printing method of claim 1, wherein each of the initial numbers is an integer greater than or equal to about 0.

12. The inkjet printing method of claim 1, wherein
each of the initial numbers has a spatial frequency in the initial sequence, and
a difference in spatial frequency between the initial numbers is about 10% or less.

13. The inkjet printing method of claim 12, wherein the initial numbers have a same spatial frequency in the initial sequence.

14. The inkjet printing method of claim 1, wherein in the discharging of droplets to the pixel areas, a driving waveform signal applied to the nozzles is changed to adjust the discharge volume of the nozzles.

15. The inkjet printing method of claim 14, wherein
the driving waveform signal has a driving section and a non-driving section before and after the driving section, and
in the discharging of droplets to the pixel areas, a magnitude of a voltage in the driving section is changed.

16. The inkjet printing method of claim 14, wherein
the driving waveform signal has a driving section and a non-driving section before and after the driving section, and
in the discharging of droplets to the pixel areas, a length of the driving section is changed.

17. The inkjet printing method of claim 14, wherein
the driving waveform signal has a driving section and a non-driving section before and after the driving section, and
in the discharging of droplets to the pixel areas, a frequency of the driving section included in the driving waveform signal is changed.

18. The inkjet printing method of claim 1, wherein
the nozzles form a nozzle row, and
in the discharging of droplets to the pixel areas, the discharge volume of each of the nozzles is individually adjusted.

19. An inkjet printing apparatus comprising:
nozzles that discharge droplets to pixel areas;
an input part where a measurement error range for discharge volume of the nozzles is input;
a calculation part which generates a correction sequence in which correction numbers are arranged in a matrix from based on a data input to the input part;
a waveform generation part which generates a driving waveform signal applied to the nozzles; and
an output part which outputs a control signal to the waveform generation part based on the correction sequence.

20. The inkjet printing apparatus of claim 19, wherein a variable range for volume of droplets discharged to the pixel areas is further input to the input part.

21. The inkjet printing apparatus of claim 20, wherein an initial sequence in which initial numbers corresponding to the pixel areas are arranged in a matrix form is further input to the input part.

22. The inkjet printing apparatus of claim 21, wherein the calculation part corrects the initial numbers with the correction numbers based on the variable range and the measurement error range.

23. The inkjet printing apparatus of claim 22, wherein
the variable range is about −A % to about +A %, the measurement error range is about −B % to about +B %, each of A and B is a positive number, and B is smaller than A, and
the correction numbers include a number calculated by Equation 1 and a number calculated by Equation 2 below:
$$A - B \qquad [ Equation 1 ]$$
$$- ( A - B ) . \qquad [ Equation 2 ]$$

24. The inkjet printing apparatus of claim 23, wherein, for remaining numbers other than a maximum value and a minimum value among the initial numbers, in case that C is a ratio of any one remaining number to a difference between the maximum value and the minimum value, the correction numbers further include a number calculated by Equation 3 below:
$$( A - B ) \times ( 2 C - 1 ) . \qquad [ Equation 3 ]$$

25. The inkjet printing apparatus of claim 22, wherein
the variable range is about −A % to about +A %, the measurement error range is about −B % to about +B %, each of A and B is a positive number, and B is smaller than 1, and
for remaining numbers other than a maximum value and a minimum value among the initial numbers, in case that C is a ratio of any one remaining number to a difference between the maximum value and the minimum value, the correction numbers include A, −A, and a number calculated by Equation 4 below:
$$A \times ( 2 C - 1 ) . \qquad [ Equation 4 ]$$

26. The inkjet printing apparatus of claim 19, wherein
the driving waveform signal has a driving section and a non-driving section before and after the driving section, and
the control signal includes at least one of a first control signal which controls a magnitude of a voltage of the driving section, a second control signal which controls a length of the driving section, and a third control signal which controls a frequency of the driving section included in the driving waveform signal.
